(19) United States
(12) Patent Application Publication
(10) Pub. No.: US 2015/0146437 A1
(43) Pub. Date: May 28, 2015

(54) LIGHT EMITTING DIODE PROJECTION BULB

(71) Applicant: Lextar Electronics Corporation, Hsinchu (TW)

(72) Inventor: Kuo-Chiang CHEN, Hsinchu County (TW)

(73) Assignee: Lextar Electronics Corporation, Hsinchu (TW)

(21) Appl. No.: 14/270,351

(22) Filed: May 5, 2014

(30) Foreign Application Priority Data
Nov. 26, 2013 (TW) 102143058

(51) Int. Cl. F21V 29/00; F21V 23/06; F21V 17/12; F21K 99/00; F21V 17/00

(52) U.S. Cl. CPC F21V 29/004; F21K 9/1375; F21V 17/002; F21V 17/12; F21V 23/06
USPC 362/373

(57) ABSTRACT

The disclosure provides a light emitting diode projection bulb including a heat dissipation base, a light emitting diode module, and a annular heat dissipation member. The heat dissipation base includes a bottom surface, a sidewall surrounding the bottom surface, and a annular rim. The annular rim is connected to an end of the sidewall to define a first opening facing toward outside. A surface of the annular rim forms a plurality of first convection holes and a plurality of first locating portions. The light emitting diode module is installed on the bottom surface of the heat dissipation base and emits light toward the first opening. The annular heat dissipation member includes a second opening, a plurality of second convection holes, and a plurality of second locating portions.

### RELATED APPLICATIONS

This application claims priority to Taiwan Application Serial Number 102143058, filed Nov. 26, 2013, which is herein incorporated by reference.

### BACKGROUND

1. Technical Field

The present disclosure relates to light emitting diode projection bulb.

2. Description of Related Art

Conventional light emitting diode projection bulbs can be classified into high efficiency and low efficiency bulbs for serving different purposes. Because of generating more heat, the high efficiency light emitting diode projection bulb requires a high efficiency heat dissipation base in contrast to the low efficiency light emitting diode projection bulb which only needs a heat dissipation base with lower efficiency for the generation of less heat.

In the production of the light emitting diode projection bulb, a manufacturer would only dispose the high efficiency heat dissipation base on all the bulbs, regardless that the efficiency the light emitting diode projection bulb performs. However, the high efficiency heat dissipation base requires more heat dissipation material, and costs more than the low efficiency heat dissipation base. It is a waste because it is unnecessary to use the high efficiency heat dissipation base in the low efficiency light emitting diode projection bulb.

On the other hand, if the manufacturer uses the high and low efficiency heat dissipation bases based on the efficiency of the light emitting diode projection bulbs, the manufacturer needs to build two different molds which also increases the costs of the production.

### SUMMARY

The disclosure provides a light emitting diode projection bulb including a heat dissipation base, a light emitting diode module, and a annular heat dissipation member. The heat dissipation base includes a bottom surface, a sidewall surrounding the bottom surface, and a annular rim. The annular rim is connected to an end of the sidewall to define a first opening facing toward outside. A surface of the annular rim forms a plurality of first convection holes and a plurality of first locating portions. The light emitting diode module is installed on the bottom surface of the heat dissipation base and emits light toward the first opening. The annular heat dissipation member includes a second opening, a plurality of second convection holes, and a plurality of second locating portions. The shape of the second opening corresponds to the shape of the first opening. The second convection holes surrounds the second opening. The second locating portions are detachably engaged to the corresponding first locating portions respectively, such that the annular heat dissipation member is joined to the annular rim of the heat dissipation base, and each of the second convection holes is aligned with the corresponding first convection holes.

In an embodiment of the present disclosure, each of the first locating portions and the second locating portions has a screw hole and a screw. The screw is fastened into the screw hole, such that the annular heat dissipation member and the heat dissipation base are detachably engaged to each other.

In an embodiment of the present disclosure, each of the second locating portions protrudes out of a surface of the annular heat dissipation member. When the annular heat dissipation member is joined to the annular rim of the heat dissipation base, an end of each of the second locating portions abuts against the corresponding first locating portion.

In an embodiment of the present disclosure, a caliber of the second opening is gradually enlarged along a direction away from the bottom surface.

In an embodiment of the present disclosure, the sidewall of the heat dissipation base includes a plurality of heat dissipation holes spaced from each other. The first convection holes correspond to the heat dissipation hole respectively.

In an embodiment of the present disclosure, a material of the heat dissipation base and a material of the annular heat dissipation member include metal or heat dissipation plastic.

In an embodiment of the present disclosure, the annular heat dissipation member and the heat dissipation base are circular.

In an embodiment of the present disclosure, the number of the first locating portions is at least two, and the number of the second locating portions is at least two.

In an embodiment of the present disclosure, the number of the first locating portions is three, and the number of the second locating portions is three.

In an embodiment of the present disclosure, the light emitting diode projection bulb further includes a pair of connecting pins connected with an end portion of the heat dissipation base and electrically connected with the light emitting diode module.

Accordingly, the present disclosure provides the light emitting diode projection bulb to solve the problem that the cost of the heat dissipation base of the conventional light emitting diode projection bulb is wasted. The heat dissipation base of the present disclosure is designed for the low efficiency light emitting diode module to dissipate the heat. The sidewall of the heat dissipation base includes the plurality of heat dissipation holes spaced from each other, and the first convection holes correspond to the heat dissipation holes respectively. When the air is driven by the heat convection force to flow in and out of the first convection holes and the heat dissipation holes, the air takes the heat inside the holes away, such that the heat is dissipated effectively. The heat dissipation base is material saving. When the heat dissipation base is used, the heat of the low efficiency light emitting diode module can be dissipated effectively, such that the heat dissipation base can not only save cost but also dissipate heat. If the light emitting diode projection bulb is equipped with the high efficiency light emitting diode module, the user only needs to join the annular heat dissipation member to the heat dissipation base, and thus the heat dissipation efficiency is enhanced effectively. The annular heat dissipation member has the second opening of which the shape corresponds to the shape of the first opening, the plurality of second convection holes surrounding the second opening, and the plurality of second locating portions. When the air is driven by the heat convection force to flow in and out of the second convection holes, the first convection holes, and the heat dissipation holes, the heat is taken away by the air, such that the temperature of the light emitting diode projection bulb can be decreased effectively. Because the light emitting diode projection bulb of the present disclosure can be equipped with the high efficiency light emitting diode module or the low efficiency light emitting diode module as needed, the purposes of effectively dissipating heat and saving the material can be achieved. Therefore, the profits of the product can be enhanced effectively.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of a light emitting diode projection bulb according to an embodiment of the present disclosure;

FIG. 2 is an exploded view of the light emitting diode projection bulb in FIG. 1;

FIG. 3 is a top view of a heat dissipation base according to an embodiment of the present disclosure;

FIG. 4 is a rear view of the heat dissipation base in FIG. 3.

FIG. 5 is a top view of a annular heat dissipation member according to an embodiment of the present disclosure; and

FIG. 6 is a rear view of the annular heat dissipation member in FIG. 5.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

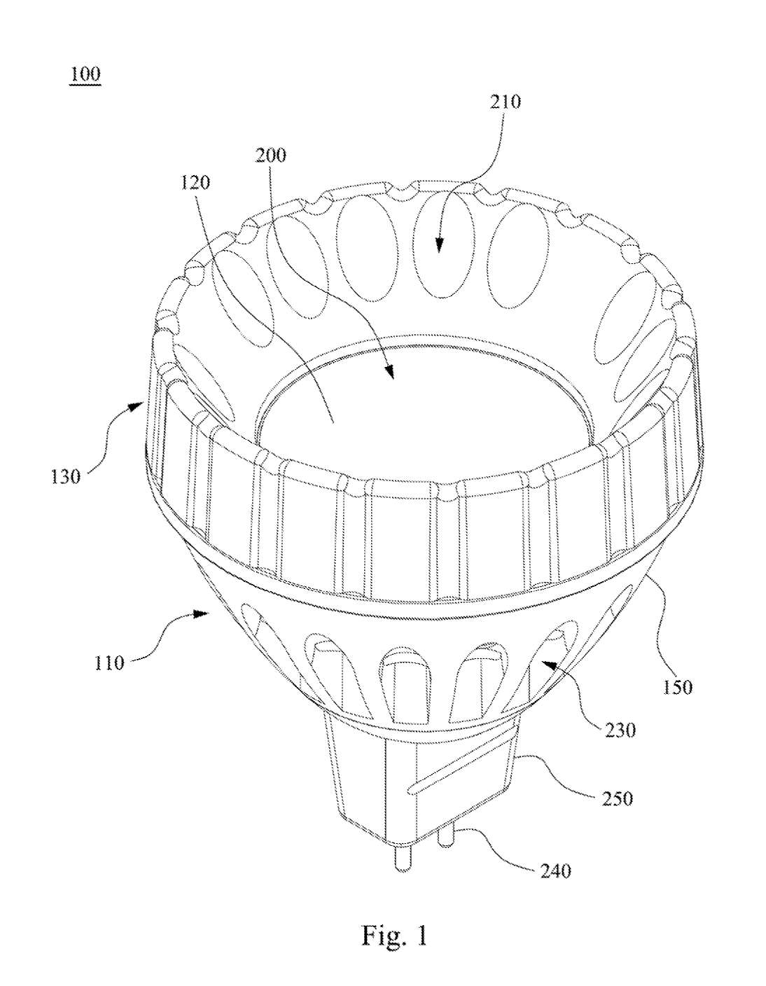

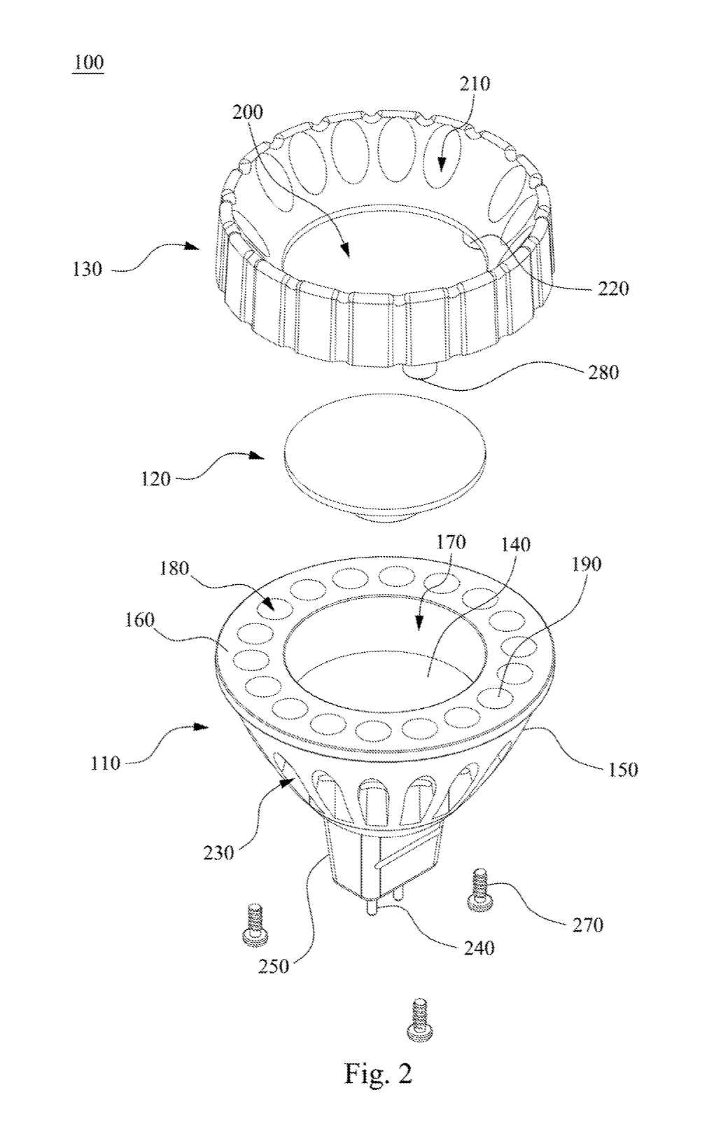

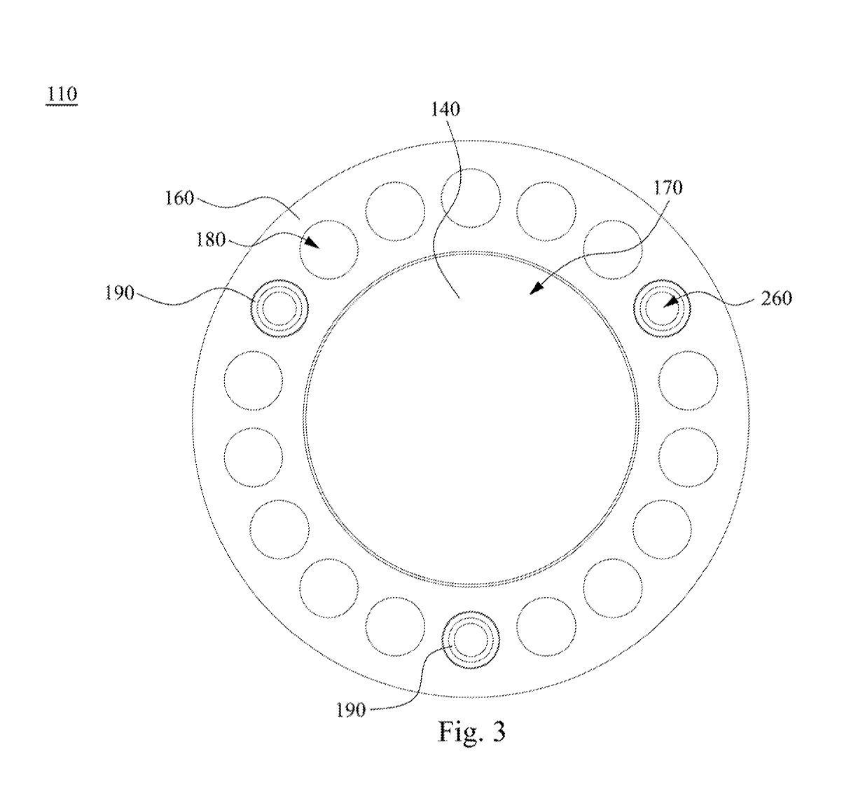

In order to solve the problem that the cost of a heat dissipation base of a conventional light emitting diode projection bulb is wasted, the present disclosure provides a light emitting diode projection bulb having a heat dissipation base that can be assembled to improve the problem. FIG. 1 is a perspective view of a light emitting diode projection bulb 100 according to an embodiment of the present disclosure. FIG. 2 is an exploded view of the light emitting diode projection bulb 100 in FIG. 1. The light emitting diode projection bulb 100 includes the heat dissipation base 110, a light emitting diode module 120, and a annular heat dissipation member 130. The heat dissipation base 110 includes a bottom surface 140, a sidewall 150 surrounding the bottom surface 140, and a annular rim 160. The annular rim 160 is connected to an end of the sidewall 150 to define a first opening 170 facing toward outside the bottom surface 140. A surface of the annular rim 160 forms a plurality of first convection holes 180 and a plurality of first locating portions 190 (referring to FIG. 3).

The light emitting diode module 120 is installed on the bottom surface 140 of the heat dissipation base 110 and emits light toward the first opening 170 of the heat dissipation base 110. The annular heat dissipation member 130 includes a second opening 200, a plurality of second convection holes 210, and a plurality of second locating portions 220. The shape of the second opening 200 corresponds to the shape of the first opening 170. The second convection holes 210 surrounds the second opening 200. The second locating portions 220 are detachably engaged to the corresponding first locating portions 190 (referring to FIG. 3) respectively, such that the annular heat dissipation member 130 is joined to the annular rim 160 of the heat dissipation base 110, and each of the second convection holes 210 is aligned with the corresponding first convection holes 180. In an embodiment of the present disclosure, the light emitting diode projection bulb 100 further includes a pair of connecting pins 240 connected with an end portion 250 of the heat dissipation base 110 and electrically connected with the light emitting diode module 120. In an embodiment of the present disclosure, each of the first locating portions 190 and the second locating portions 220 has a screw hole. After a plurality of screws 270 are screwed into the screw holes respectively, the heat dissipation base 110 can be fastened to the annular heat dissipation member 130. The screws 270 can be removed as needed, such that the annular heat dissipation member 130 and the heat dissipation base 110 are detachably engaged. In an embodiment of the present disclosure, each of the second locating portions 220 protrudes out of a surface of the annular heat dissipation member 130. When the annular heat dissipation member 130 is joined to the annular rim 160 of the heat dissipation base 110 an end of each of the second locating portions 220 abuts against the corresponding first locating portion 190. In an embodiment of the present disclosure, a material of the heat dissipation base 110 and a material of the annular heat dissipation member 130 include metal or heat dissipation plastic.

People having ordinary skill in the art can make proper modification to the materials of the heat dissipation base 110 and the annular heat dissipation member 130 according to their actual needs.

The heat dissipation base 110 is material saving. The heat dissipation base 110 is applicable for a low efficiency light emitting diode module to dissipate heat. Hence, the heat dissipation base 110 cannot only save the cost but also can dissipate heat. When the light emitting diode projection bulb 100 is equipped with a high efficiency light emitting diode module, a user only needs to join the annular heat dissipation member 130 to the heat dissipation base 110 to increase the entire surface area for dissipating heat, and thus the heat dissipation efficiency can be enhanced.

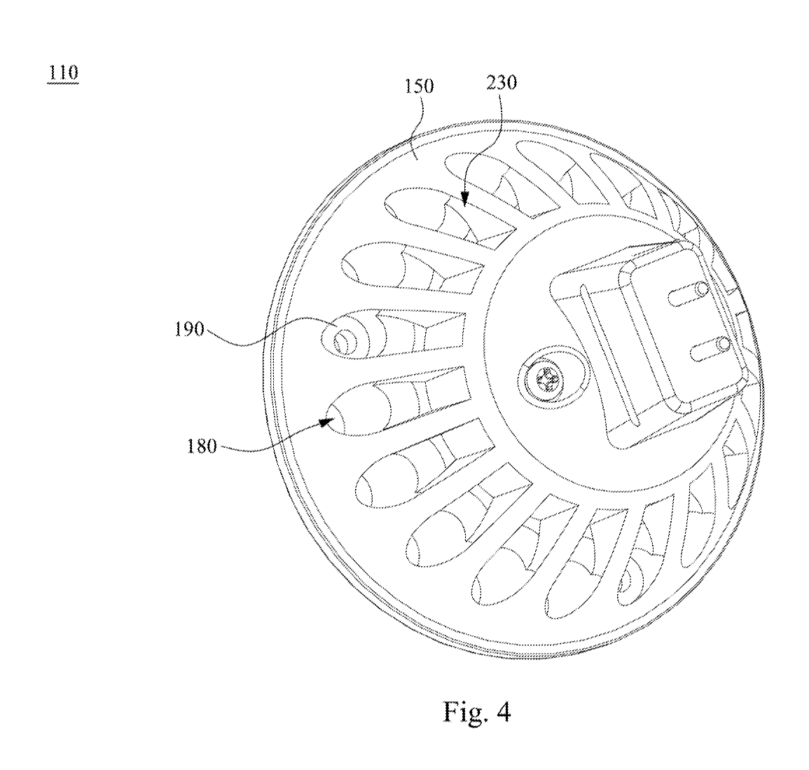

FIG. 3 is a top view of the heat dissipation base 110 according to an embodiment of the present disclosure. FIG. 4 is a rear view of the heat dissipation base 110 in FIG. 3. The heat dissipation base 110 is designed for the low efficiency light emitting diode module to dissipate heat. The heat dissipation base 110 is material saving. The heat dissipation base 110 is applicable for a low efficiency light emitting diode module to dissipate heat. Hence, the heat dissipation base 110 cannot only save the cost but also can dissipate heat. The heat dissipation base includes a bottom surface 140, a sidewall 150 surrounding the bottom surface 140, and a annular rim 160. The annular rim 160 is connected to an end of the sidewall 150 to define a first opening 170 facing toward outside the bottom surface 140. A surface of the annular rim 160 forms a plurality of first convection holes 180 and a plurality of first locating portions 190. The light emitting diode module 120 (referring to FIG. 2) is installed on the bottom surface 140 of the heat dissipation base 110 and emits light toward the first opening 170 of the heat dissipation base 110. In an embodiment of the present disclosure, the heat dissipation base 110 is circular. In an embodiment of the present disclosure, the sidewall 150 of the heat dissipation base 110 includes a plurality of heat dissipation holes 230 spaced from each other. The first convection holes 180 correspond to the heat dissipation holes 230 respectively. When an air is driven by a heat convection force to enter the first convection holes 180 and the heat dissipation holes 230, the air can takes the heat away from the holes, such that the heat is effectively dissipated. In an embodiment of the present disclosure, the number of the first locating portions 190 is at least two. In an embodiment of the present disclosure, the number of the first locating portions 190 is three. Each of the first locating portions 190 includes a screw hole 260 that can be fastened by a screw, so that the first locating portions 190 can be fastened to the heat dissipation base 110.

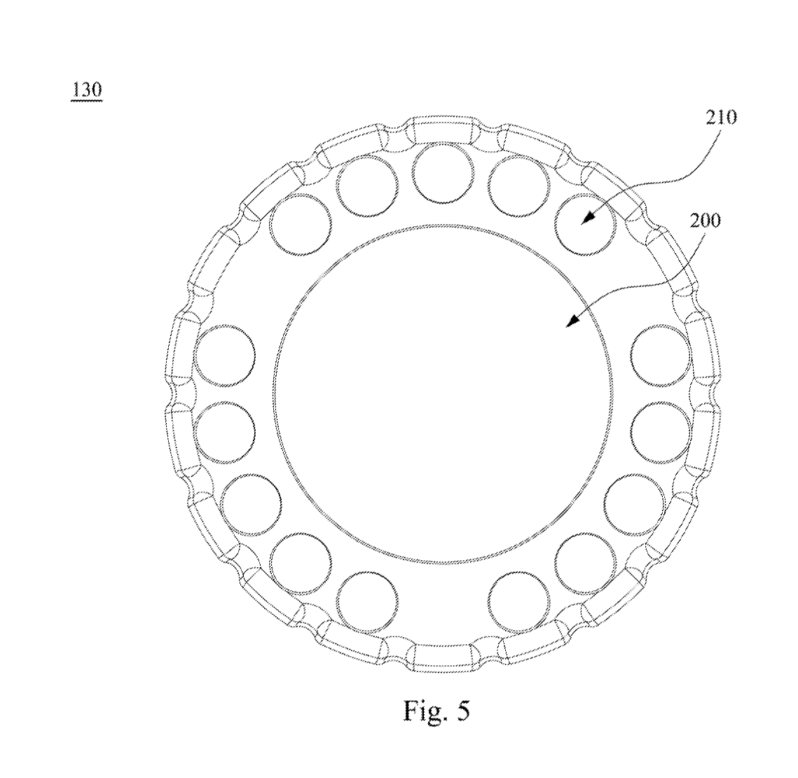

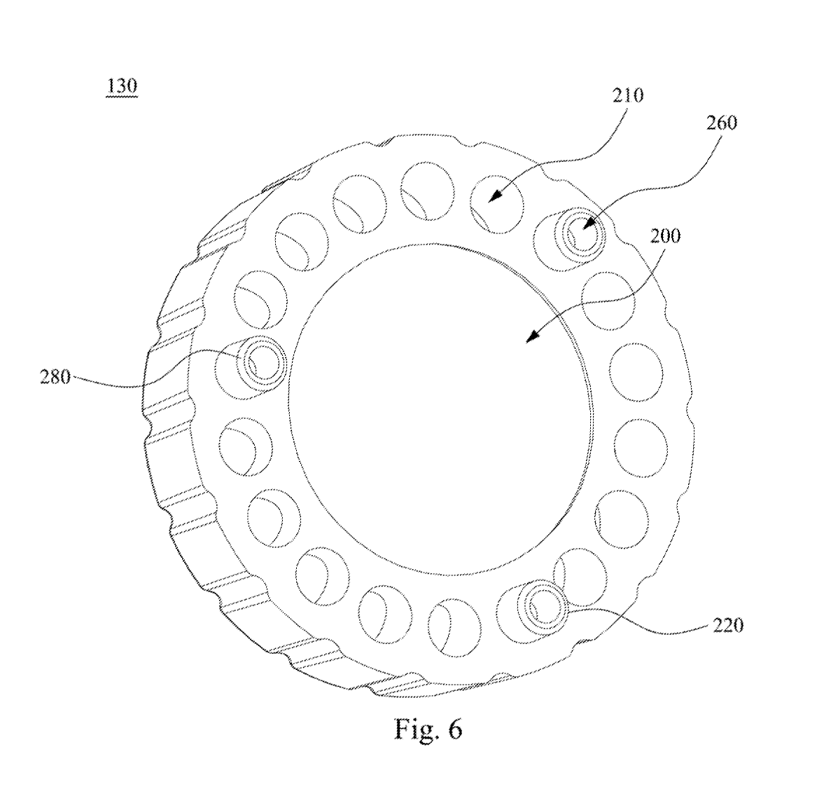

FIG. 5 is a top view of the annular heat dissipation member 130 according to an embodiment of the present disclosure. FIG. 6 is a rear view of the annular heat dissipation member 130 in FIG. 5. When the light emitting diode projection bulb 100 is equipped with a high efficiency light emitting diode module, a user only needs to join the annular heat dissipation member 130 to the heat dissipation base 110 to increase the entire surface area for dissipating heat, and thus the heat dissipation efficiency can be enhanced. The annular heat dissipation member 130 includes a second opening 200, a plurality of second convection holes 210, and a plurality of second locating portions 220. The shape of the second opening 200 corresponds to the shape of the first opening 170 (referring to FIG. 3). The second convection holes 210 surrounds the second opening 200. In other words, if the first opening 170 (referring to FIG. 3) is circular, the second opening 200 is also circular, and the sizes of openings are approximately the same. In an embodiment of the present disclosure, a caliber of the second opening 200 is gradually enlarged along a direction away from the bottom surface 140 (referring to FIG. 3), such that the second opening 200 will not obscure light. When the annular heat dissipation member 130 is joined to the heat dissipation base 110 (referring to FIG. 3), and the second convection holes 210 are respectively aligned with the first convection holes 180 (referring to FIG. 3), the air is driven by the heat convection force to enter the second convection holes 210, the first convection holes 180 (referring to FIG. 4) and the heat dissipation holes 230 (referring to FIG. 4). The air can take the heat away from the holes, such that the temperature of the light emitting diode projection bulb 100 is decreased. The second locating portions 220 are detachably engaged to the first locating portions 190 (referring to FIG. 3) respectively. Therefore, the annular heat dissipation member 130 can be joined to the annular rim 160 of the heat dissipation base 110 (referring to FIG. 3) or can be disengaged from the heat dissipation base 110 (referring to FIG. 3) as needed. In an embodiment of the present disclosure, the annular heat dissipation member 130 is circular. In an embodiment of the present disclosure, the number of the second locating portions 220 is at least two. In an embodiment of the present disclosure, the number of the second locating portions 220 is three. Each of the second locating portions 220 includes a screw hole 260 that can be fastened by a screw, so that the second locating portions 220 can be fastened to the annular heat dissipation member 130.

Accordingly, the present disclosure provides the light emitting diode projection bulb to solve the problem that the cost of the heat dissipation base of the conventional light emitting diode projection bulb is wasted. The heat dissipation base of the present disclosure is designed for the low efficiency light emitting diode module to dissipate the heat. The sidewall of the heat dissipation base includes the plurality of heat dissipation holes spaced from each other, and the first convection holes correspond to the heat dissipation holes respectively. When the air is driven by the heat convection force to flow in and out of the first convection holes and the heat dissipation holes, the air takes the heat inside the holes away, such that the heat is dissipated effectively. The heat dissipation base is material saving. When the heat dissipation base is used, the heat of the low efficiency light emitting diode module can be dissipated effectively, such that the heat dissipation base can not only save cost but also dissipate heat. If the light emitting diode projection bulb is equipped with the high efficiency light emitting diode module, the user only needs to join the annular heat dissipation member to the heat dissipation base, and thus the heat dissipation efficiency is enhanced effectively. The annular heat dissipation member has the second opening of which the shape corresponds to the shape of the first opening, the plurality of second convection holes surrounding the second opening, and the plurality of second locating portions. When the air is driven by the heat convection force to flow in and out of the second convection holes, the first convection holes, and the heat dissipation holes, the heat is taken away by the air, such that the temperature of the light emitting diode projection bulb can be decreased effectively. Because the light emitting diode projection bulb of the present disclosure can be equipped with the high efficiency light emitting diode module or the low efficiency light emitting diode module as needed, the purposes of effectively dissipating heat and saving the material can be achieved. Therefore, the profits of the product can be enhanced effectively.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fail within the scope of the following claims.

What is claimed is:

1. A light emitting diode projection bulb, comprising:
a heat dissipation base having a bottom surface, a sidewall surrounding the bottom surface, and a annular rim connected to an end of the sidewall to define a first opening facing toward outside, wherein a surface of the annular rim forms a plurality of first convection holes and a plurality of first locating portions;
a light emitting diode module installed on the bottom surface of the heat dissipation base and emitting light toward the first opening; and
a annular heat dissipation member having a second opening of which the shape corresponds to the shape of the first opening, a plurality of second convection holes surrounding the second opening, and a plurality of second locating portions, the second locating portions being detachably engaged to the corresponding first locating portions respectively, such that the annular heat dissipation member is joined to the annular rim of the heat dissipation base, and each of the second convection holes is aligned with the corresponding first convection holes.

2. The light emitting diode projection bulb of claim 1, wherein each of the first locating portions and the second locating portions has a screw hole and a screw which is fastened into the screw hole, such that the annular heat dissipation member and the heat dissipation base are detachably engaged to each other.

3. The light emitting diode projection bulb of claim 2, wherein each of the second locating portions protrudes out of a surface of the annular heat dissipation member, and when the annular heat dissipation member is joined to the annular rim of the heat dissipation base, an end of each of the second locating portions abuts against the corresponding first locating portion.

4. The light emitting diode projection bulb of claim 3, wherein a caliber of the second opening is gradually enlarged along a direction away from the bottom surface.

5. The light emitting diode projection bulb of claim 4, wherein the sidewall of the heat dissipation base comprises a plurality of heat dissipation holes spaced from each other, and the first convection holes respectively correspond to the heat dissipation hole.

6. The light emitting diode projection bulb of claim 1, wherein a material of the heat dissipation base and a material of the annular heat dissipation member comprise metal or heat dissipation plastic.

7. The light emitting diode projection bulb of claim 1, wherein the annular heat dissipation member and the heat dissipation base are circular.

8. The light emitting diode projection bulb of claim 1, wherein the number of the first locating portions is at least two, and the number of the second locating portions is at least two.

9. The light emitting diode projection bulb of claim 8, wherein the number of the first locating portions is three, and the number of the second locating portions is three.

10. The light emitting diode projection bulb of claim 1, further comprising a pair of connecting pins connected with an end portion of the heat dissipation base and electrically connected with the light emitting diode module.
